(19) United States
(12) Patent Application Publication
(10) Pub. No.: US 2022/0396681 A1
(43) Pub. Date: Dec. 15, 2022

(54) POLYMER COMPOSITION

(71) Applicant: VICTORIA LINK LIMITED, Wellington (NZ)

(72) Inventors: Konstantinos BOULOUKAKIS, Lower Hutt (NZ); Benjamin John PARKINSON, Lower Hutt (NZ)

(21) Appl. No.: 17/642,772

(22) PCT Filed: Sep. 18, 2020
(86) PCT No.: PCT/NZ2020/050106

§ 371 Date: Mar. 14, 2022

(30) Foreign Application Priority Data
Sep. 18, 2019 (GR) 20190100402

(51) Int. Cl. C08K 3/22; C08K 7/16; C08K 9/02; C08K 3/04; C08K 3/08

(52) U.S. Cl. CPC C08K 3/22; C08K 7/16; C08K 9/02; C08K 3/042; C08K 3/046; C08K 3/08; C08K 2201/001; C08K 2201/005; C08K 2003/085; C08K 2003/2227

(57) ABSTRACT

A polymer composition for impregnating a high temperature superconductor (HTS) coil, the composition comprising: a polymer resin, a plurality of particles of a first filler material, and a plurality of particles of a second filler material; wherein the median particle size of the second filler material is less than the median particle size of the first filler material. The polymer composition may be used to prepare a polymer impregnated HTS coil having a predetermined turn-to-turn spacing. A property of the polymer composition may also be modified, for example, the coefficient of thermal contraction and/or resistivity of the composition. Also disclosed is a polymer impregnated HTS coil and a method for preparing the coil.

### TECHNICAL FIELD

The present invention generally relates to a polymer composition for impregnating a high temperature superconductor (HTS) coil. The present invention also relates to a polymer impregnated HTS coil and a method for preparing the coil.

### BACKGROUND ART

HTS coils are a convenient means to generate strong magnetic fields with limited power dissipation, providing higher magnetic fields or higher operating temperatures compared to traditional low temperature superconductors (LTS). This technology is useful in various applications including medical imaging, nuclear magnetic resonance spectroscopy, particle accelerators, generators such as wind turbine generators, and energy storage.

One issue with HTS coil design is managing mechanical stress. A conductor carrying current in a magnetic field will experience a Lorentz force. For superconducting magnets, the high current density, large magnetic fields and large sizes can mean substantial Lorentz forces are generated. These Lorentz forces must be managed within the coil structure.

A common method of mechanically stabilising an HTS coil is by impregnating the coil with a polymer resin. However, HTS conductor is often manufactured as a coated conductor, with consequent poor inter-layer (c-axis) strength within the coated conductor stack. During cool-down of the coil to the cryogenic operational temperatures of HTS, the mismatch between the coefficient of thermal contraction of the polymer resin and other materials of the coil causes a strain to be applied along the c-axis of the HTS conductor stack. If the resulting stress in the conductor stack is sufficient to exceed the inter-layer bonding within the stack, this results in delamination of the coated conductor and consequent loss of superconductivity. Several approaches to impregnating a coil with a polymer resin have been explored to prevent delamination. One approach is to use a low modulus resin system, or to prevent bonding of the resin system to conductor faces, which in both cases prevents transfer of strain into the coated conductor stack. Another approach is to add into the polymer resin a filling material with a low (compared to the polymer resin) or zero coefficient of thermal contraction and hence reduce the coefficient of thermal contraction. Such an approach has been exemplified through addition of silica powder (Barth et al. Supercond Sci Technol 2013, 26 (5), 1-10) or alumina powder (Park et al. J Electr Eng Technol 2018, 13(3), 1166-1172) to the polymer resin, both of which have been shown to reduce conductor delamination during cool down.

Another key factor in HTS coil design is managing quench. Quench occurs when a superconductor transitions from the superconducting state to a normal (resistive) state. Upon quench, the energy being carried by the superconductor dissipates by Joule heating in the resistive section of the formerly superconductive wire. The result of a local quench in a coil with good electrical insulation between turns of the coil is that the coil's stored energy starts to become dissipated as heat in this region. For traditional LTS, which have low minimum quench energy, the local heating is sufficient to cause adjacent superconducting areas to become normal (resistive), creating a large normal zone within the coil. Through this mechanism the stored energy of the coil may be safely dissipated over a large volume of the coil, resulting in acceptable hot spot temperatures in the coil. By contrast, HTS minimum quench energy is much higher, so the normal zone does not propagate with the same ease that an LTS normal zone may. Consequently, regions adjacent to the quenched region may not become normal resulting in a small normal zone. Since the coil energy is being dissipated over a much smaller proportion of the coil volume, the hot-spot temperature may become damagingly high.

An emerging strategy for managing quench in HTS coils is to prepare coils having a finite turn-to-turn resistance. Reducing the turn-to-turn resistance of coils has been demonstrated to produce self-protecting coils, supporting currents many times the critical current of the coil without damage to the coil (see Hahn et al. IEEE Trans. Appl. Supercond. 2011 21(3) 1592-1595). Upon injection of a fixed current into a coil with finite turn-to-turn resistance, current in that coil will split into a component flowing in the radial direction and a component flowing in the circumferential direction, according to the difference between the inductive and resistive (i.e. turn-to-turn) components of voltage experienced by the current. An undesirable consequence of this phenomenon, however, is that reducing resistance between turns leads to a ‘charging-delay’, which is the time it takes for all the current to shift from flowing in the circumferential direction to the radial direction. Therefore, it is desirable to be able to modify the turn-to-turn resistance of an HTS coil based on the requirements of different applications.

Various techniques for preparing an HTS coil with finite turn-to-turn resistance have been investigated. One technique is to co-wind the coil with a copper plating on either side of the superconductor wire with no further insulation between turns (see Wang et al. Supercond Sci Technol 2013, 26, 1-6). Others have investigated placing non-copper metals between adjacent turns to increase the turn-to-turn resistance (see Markiewicz et al. Supercond Sci Technol 2016, 29, 1-11). One approach is to add an additional turn of metal in between the two superconductor wires. Another approach is to deposit a thin layer of additional metal on top of the copper plating on the superconducting wire, for example stainless steel. A final approach that has been investigated is addition of a silver powder to the epoxy resin of an epoxy impregnated coil to increase the electrical conductivity of the resin (see Hwang et al. IEEE Trans Appl Supercond 2017, 27(4), 1-5).

Polymer impregnated coils may be prepared by a wet winding method or a vacuum impregnation method. Wet winding involves directly painting the polymer resin onto the surface of one or more of the coil winding components, for example the superconductor, immediately before the conductor is wound into the coil. Once the coil is wound, the polymer is cured. A coil designer will usually specify a particular turn-to-turn thickness the coil must achieve to give the desired current density and coil dimensions. Due to the imprecise process of applying the polymer wet to the surface of conductor, tuneable and precise turn-to-turn thickness is difficult to achieve. An alternative method is the vacuum impregnation method. Using this method, the coil is wound without the polymer, and hence with good dimensional control, and then placed into a vacuum tight mould. Air is evacuated from the mould and coil, and the polymer resin is allowed to flow into the mould and coil, completely filling any voids in the coil structure. In such resin infusion, a low viscosity resin system must be used to ensure the resin can fully penetrate the coil structure. Consequently, the wet winding method is more suitable for preparing a coil impregnated with a viscous polymer system.

It is an object of the present invention to go some way to avoiding the above disadvantages; and/or to at least provide the public with a useful choice.

Other objects of the invention may become apparent from the following description which is given by way of example only.

Unless otherwise stated, the entire content of any document cited herein is incorporated herein by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In one aspect, the present invention provides a polymer composition comprising: a polymer resin, a plurality of particles of a first filler material, and a plurality of particles of a second filler material; wherein the median particle size of the second filler material is less than the median particle size of the first filler material.

In another aspect, the present invention provides a polymer composition for impregnating a high temperature superconductor (HTS) coil, the composition comprising: a polymer resin, a plurality of particles of a first filler material, and a plurality of particles of a second filler material; wherein the median particle size of the second filler material is less than the median particle size of the first filler material.

In some embodiments, the aspect ratio of the particles of a first filler material is above about 0.80, or above about 0.85, or above about 0.90, or above about 0.95, or above about 0.99.

In some embodiments, the particles of the first filler material are substantially spherical or substantially cubic. In some embodiments, the first filler material is substantially cubic.

In some embodiments, the median particle size of the first filler material is about 5 μm to about 100 μm, or about 5 μm to about 50 μm, or about 5 μm to about 40 μm, or about 5 μm to about 30 μm, or about 9.5 μm to about 50 μm, or about 9.5 μm to about 40 μm, or about 9.5 μm to about 29 μm, or about 25.2 μm, or about 25 μm, or about 12.5 μm , or about 12.4 μm.

In some embodiments, the median particle size of the first filler material has a standard deviation of about 10 μm, or about 9 μm, or about 8 μm, or about 7 μm, or about 6 μm, or about 5 μm, or about 4 μm, or about 3 μm, or about 2 μm, or about 1 μm.

In some embodiments, the median particle size of the first filler material has a standard deviation of about 40% of the particle size. Preferably, the median particle size of the first filler material has a standard deviation of less than about 50% of the particle size, or less than about 40% of the particle size, or less than about 30% of the particle size, or less than about 25% of the particle size, or less than about 20% of the particle size, or less than about 15% of the particle size, or less than about 10% of the particle size, or less than about 5% of the particle size. More preferably, the first filler material has a standard deviation of less than about 10% of the particle size.

In some embodiments, the maximum particle size of the second filler material is less than the median particle size of the first filler material.

In some embodiments, the maximum particle size of the second filler material is at least about 30% less than the median particle size of the first filler material.

In some embodiments, the maximum particle size of the second filler material is less than about 3 μm.

In some embodiments, the first filler material and the second filler material are independently selected from the group consisting of a material having a low coefficient of thermal contraction and an electrically conductive material.

In some embodiments, the material having a low coefficient of thermal contraction is selected from the group consisting of silica, quartz, carbon powder, diamond, amorphous diamond, boron nitride, alumina, aluminium nitride, zinc oxide, zirconium oxide, magnesium oxide and mixtures of any two or more thereof. In some embodiments, the material having a low coefficient of thermal contraction is selected from the group consisting of silica, quartz, carbon powder, amorphous diamond, boron nitride, alumina, aluminium nitride, zinc oxide, zirconium oxide, magnesium oxide and mixtures of any two or more thereof.

In some embodiments, the material having a low coefficient of thermal contraction is selected from the group consisting of silica, quartz, carbon powder, diamond, amorphous diamond, boron nitride, alumina, aluminium nitride, zinc oxide, zirconium oxide and magnesium oxide. In some embodiments, the material having a low coefficient of thermal contraction is selected from the group consisting of silica, quartz, carbon powder, amorphous diamond, boron nitride, alumina, aluminium nitride, zinc oxide, zirconium oxide and magnesium oxide.

In some embodiments, the electrically conductive material is selected from the group consisting of metals, metal oxides, carbon and mixtures of any two or more thereof.

In some embodiments, the electrically conductive material is selected from the group consisting of metals, metal oxides and carbon.

In some embodiments, the metals or metal oxides are selected from the group consisting of chromium, nickel, copper, silver, gold, aluminium, titanium, oxides thereof and mixtures of any two or more thereof.

In some embodiments, the metals or metal oxides are selected from the group consisting of chromium, nickel, copper, silver, gold, aluminium, titanium and oxides thereof.

In some embodiments, the carbon is selected from the group consisting of carbon powder, carbon black, carbon fibres, carbon nanofibres, graphite, graphene and mixtures of any two or more thereof.

In some embodiments, the carbon is selected from the group consisting of carbon powder, carbon black, carbon fibres, carbon nanofibres, graphite and graphene.

In some embodiments, the first filler material is diamond. Preferably, the first filler material is amorphous diamond.

In some embodiments, the particles of the first filler material comprise a coating of an electrically conductive material. Preferably, the electrically conductive material is selected from the group consisting of metals and metal oxides. More preferably, the metals and metal oxides are selected from the group consisting of chromium, nickel, copper, silver, gold, aluminium, titanium, oxides thereof and mixtures of any two or more thereof. Most preferably, the metal is titanium.

Accordingly, in some embodiments, the particles of the first filler material comprise a material having a low coefficient of thermal contraction coated with an electrically conductive material. Preferably, the first filler material is titanium coated diamond. In some embodiments, the polymer composition further comprises a plurality of particles of a third filler material, wherein the median particle size of the third filler material is less than the median particle size of the first filler material.

In some embodiments, the maximum particle size of the third filler material is less than the median particle size of the first filler material.

In some embodiments, the maximum particle size of the third filler material is at least about 30% less than the median particle size of the first filler material.

In some embodiments, the polymer composition comprises a plurality of particles of a third filler material, wherein the median particle size of the third filler material is substantially equal to the median particle size of the first filler material.

In some embodiments, the third filler material is selected from the group consisting of a material having a low coefficient of thermal contraction and an electrically conductive material.

In some embodiments, the first and second filler materials have a low coefficient of thermal contraction and the third filler material is electrically conductive.

In some embodiments, the first filler material is amorphous diamond, the second filler material is alumina and the third filler material is copper flakes.

In some embodiments, the first filler material is titanium coated diamond, the second filler material is alumina and the third filler material is amorphous diamond.

In some embodiments, the particles of the first filler material comprise a material having a low coefficient of thermal contraction coated with an electrically conductive material and the particles of the second filler material comprise a material having a low coefficient of thermal contraction coated with an electrically conductive material. The material having a low coefficient of thermal contraction in the particles of the first filler material may be the same as the material having a low coefficient of thermal contraction in the particles of the second filler material. Alternatively, the material having a low coefficient of thermal contraction in the particles of the first filler material may be different from the material having a low coefficient of thermal contraction in the particles of the second filler material. Similarly, the electrically conductive material comprising the coating of the particles of the first filler material may be the same as the electrically conductive material comprising the coating of the particles of the second filler material. Alternatively, the electrically conductive material comprising the coating of the particles of the first filler material may be different from the electrically conductive material comprising the coating of the particles of the second filler material.

In some embodiments, the polymer resin is selected from the group consisting of epoxies, polyimides, polyethylenes, polyacrylates, polyurethanes and combinations of any two or more thereof.

In some embodiments, the polymer resin is selected from the group consisting of epoxies, polyimides, polyethylenes, polyacrylates, and polyurethanes.

In some embodiments, the polymer resin is an epoxy.

In another aspect, the present invention provides a polymer impregnated HTS coil comprising: a winding component comprising an HTS material, wherein the coil is impregnated with the polymer composition of the invention.

In another aspect, the present invention provides a method of preparing a polymer impregnated HTS coil, the method comprising the steps of:
a) providing a winding component comprising an HTS material,
b) applying the polymer composition of the invention to the winding component,
c) winding the coated winding component obtained from step b) into a coil, and
d) curing the coil obtained from step c) to provide the polymer impregnated HTS coil.

In another aspect, the present invention provides a method of preparing a polymer impregnated HTS coil having a predetermined turn-to-turn spacing, the method comprising the steps of:
a) providing a winding component comprising an HTS material,
b) applying the polymer composition of the invention to the winding component,
c) winding the coated winding component obtained from step b) into a coil, and
d) curing the coil obtained from step c) to provide the polymer impregnated HTS coil.

In some embodiments, step b) and step c) are performed concurrently.

In some embodiments, the winding component further comprises one or more co-wind materials.

In some embodiments, the one or more co-wind materials are independently selected from the group consisting of aluminium, copper, copper alloys (such as brass), silver, titanium, steel and nickel-molybdenum alloys. In some embodiments, the one or more co-wind materials are independently selected from the group consisting of aluminium, copper, silver, titanium, steel and nickel-molybdenum alloys.

In some embodiments, the HTS material is a REBCO tape.

In another aspect, the present invention provides use of the polymer composition of the invention for preparing a polymer impregnated HTS coil.

In another aspect, the present invention provides use of the polymer composition of the invention for preparing a polymer impregnated HTS coil having a predetermined turn-to-turn spacing.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein “(s)” following a noun means the plural and/or singular forms of the noun.

As used herein the term “and/or” means “and” or “or” or both.

The term “comprising” as used in this specification means “consisting at least in part of”. When interpreting each statement in this specification that includes the term “comprising”, features other than that or those prefaced by the term may also be present. Related terms such as “comprise”, “comprised” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term “gauging particle”, as used herein, refers to particles useful in the present invention for setting the turn-to-turn spacing of an HTS coil.

The term “maximum particle size”, as used herein, refers to the D₉₅ value of a population distribution of particles.

As used herein, the term “turn-to-turn spacing” refers to the distance between turns of a coil measured from opposing faces of the superconductor material. This distance may also be referred to as “turn-to-turn distance”.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

The invention will now be described with reference to the Figures in which:

FIG. 1 is a cross section of an HTS coil impregnated with a polymer composition that does not contain gauging particles.

FIG. 2 shows cross sections of a polymer impregnated HTS coil comprising gauging particles. FIG. 2A is an overall cross section of the coil. FIG. 2B is a cross section through the coil near the inner diameter. FIG. 2C is a cross section through the coil near the middle of the winding. FIG. 2D is a cross section through the coil near the outer diameter of the winding.

FIG. 3 is a graph of contact resistivity vs concentration of copper for three test coils.

FIG. 4 is a graph of critical current performance of a polymer impregnated HTS coil, comprising gauging particles and a material having a low coefficient of thermal contraction, upon repeated thermal cycling.

FIG. 5 is a graph of the contact resistivity vs concentration of titanium-coated diamonds for four test coils.

FIG. 6 is a graph of contact resistivity vs temperature for four test coils.

### DETAILED DESCRIPTION OF THE INVENTION

The present inventors have surprisingly determined that certain filler materials, when incorporated into a polymer composition, are useful for setting the turn-to-turn spacing of a polymer impregnated HTS coil.

Accordingly, in one aspect, the present invention provides a polymer composition comprising: a polymer resin, a plurality of particles of a first filler material, and a plurality of particles of a second filler material; wherein the median particle size of the second filler material is less than the median particle size of the first filler material. More particularly, the polymer composition is useful for impregnating an HTS coil.

The first filler material is included in the polymer composition for setting the turn-to-turn spacing of the resulting polymer impregnated HTS coil, i.e. as a gauging particle. Advantageously, the first filler material has a larger median particle size than the median particle size of any additional filler materials included in the polymer composition. Those persons skilled in the art can select the particle size of the first filler material to provide the desired turn-to-turn spacing of the polymer impregnated HTS coil.

In some embodiments, the median particle size of the first filler material is about 5 μm to about 100 μm, or about 5 μm to about 50 μm, or about 5 μm to about 40 μm, or about 5 μm to about 30 μm, or about 9.5 μm to about 50 μm, or about 9.5 μm to about 40 μm, or about 9.5 μm to about 29 μm, or about 25.2 μm, or about 25 μm, or about 20 μm, or about 12.5 μm , or about 12.4 μm.

Preferably, the particles of the first filler material have a narrow particle size distribution. For example, the particle size may have a standard deviation from the median particle size of about 50% of the particle size, or about 40% of the particle size, or about 30% of the particle size, or about 25% of the particle size, or about 20% of the particle size, or about 15% of the particle size, or about 10% of the particle size, or about 5% of the particle size. In some embodiments, the particle size has a standard deviation from the median particle size of less than about 50% of the particle size, or less than about 40% of the particle size, or less than about 30% of the particle size, or less than about 25% of the particle size, or less than about 20% of the particle size, or less than about 15% of the particle size, or less than about 10% of the particle size, or less than about 5% of the particle size. In some embodiments, the median particle size of the first filler material has a standard deviation of about 10 μm, or about 9 μm, or about 8 μm, or about 7 μm, or about 6 μm, or about 5 μm, or about 4 μm, or about 3 μm, or about 2 μm, or about 1 μm.

Preferably, the particles of the first filler material have a high aspect ratio, i.e. an aspect ratio approaching 1. For example, the particles of the first filler material may have an aspect ratio above about 0.80, or above about 0.85, or above about 0.90, or above about 0.95, or above about 0.99, or an aspect ratio of 1. In some embodiments, the particles of the first filler material are substantially spherical or substantially cubic. In some embodiments, it is preferred that the particles of the first filler material are substantially cubic. For example, when the first filler material is an electrically conductive material, or when the particles of the first filler material comprise a coating of an electrically conductive material.

The polymer composition comprises at least one additional filler material, i.e. a second filler material. The polymer composition may comprise any number of additional filler materials, for example, a third filler material, a fourth filler material, and so on, provided that the median particle size of any additional filler materials is substantially equal to or less than the median particle size of the first filler material.

In some embodiments, each additional filler material has a median particle size less than the median particle size of the first filler material. Preferably, each additional filler material has a maximum particle size less than the median particle size of the first filler material. In some embodiments, the maximum particle size of each additional filler material is at least about 10% less than the median particle size of the first filler material, or at least about 20% less than the median particle size of the first filler material, or at least about 30% less than the median particle size of the first filler material, or at least about 40% less than the median particle size of the first filler material, or at least about 50% less than the median particle size of the first filler material, or at least about 60% less than the median particle size of the first filler material, or at least about 70% less than the median particle size of the first filler material, or at least about 80% less than the median particle size of the first filler material, or at least about 90% less than the median particle size of the first filler material. In those embodiments wherein there is more than one additional filler material, the maximum particle size of each additional filler material may be selected independently of the particle size of any other additional filler material. In some embodiments, the maximum particle size of each additional filler material is less than about 5 μm, or less than about 4 μm, or less than about 3 μm, or less than about 2 μm, or less than about 1 μm, or less than about 0.5 μm.

In some embodiments, the polymer composition comprises a first filler material, a second filler material, and a third filler material, wherein the second filler material has a median particle size less than the median particle size of the first filler material and the third filler material has a median particle size substantially equal to the median particle size of the first filler material.

Any of the filler materials according to the present invention may be a functional material that modifies a property of the polymer composition, for example, the coefficient of thermal contraction and/or electrical conductivity of the polymer composition. Alternatively, any of the filler materials may be an inert material.

In some embodiments, at least one filler material is a material having a low coefficient of thermal contraction. Such a material may be used to modify the coefficient of thermal contraction of the polymer composition, and preferably match or approximately match the coefficient of thermal contraction of the polymer composition to that of the other components of the HTS coil. Advantageously, this may reduce delamination of the coil at low temperatures. Materials having a low coefficient of thermal contraction that are suitable for use in the present invention include, for example, silica, quartz, carbon powder, diamond (such as amorphous diamond), boron nitride, alumina, aluminium nitride, zinc oxide, zirconium oxide and magnesium oxide. The invention is not, however, limited thereto, and other materials may be used. Advantageously, the material having a low coefficient of thermal contraction may have a relatively good thermal conductivity. In some embodiments, the material having a low coefficient of thermal contraction is diamond (such as amorphous diamond), alumina or magnesium oxide.

In some embodiments, at least one filler material is an electrically conductive material. Electrically conductive materials may be included in the polymer composition to modify the resistivity of the polymer composition. Advantageously, those persons skilled in the art can select a suitable electrically conductive material to achieve the desired turn-to-turn resistivity in the resulting polymer impregnated HTS coil. Those persons skilled in the art will appreciate that turn-to-turn resistivity will be affected by, for example, the particle size of the electrically conductive material, the concentration of the electrically conductive material, the concentration of any non-conductive material(s), and the turn-to-turn spacing of the coil.

Suitable electrically conductive materials include, for example, metals and metal oxides such as chromium, nickel, copper, silver, gold, aluminium, titanium, oxides thereof and mixtures of any two or more thereof; and carbon, which may be in the form of, for example, carbon powder, carbon black, carbon fibres, carbon nanofibres, graphite, graphene and mixtures of any two or more thereof. In some embodiments, the metals or metal oxides are selected from the group consisting of copper, silver, gold, aluminium, oxides thereof and mixtures of any two or more thereof. In some embodiments, the metals or metal oxides are selected from the group consisting of copper, silver, gold, aluminium and oxides thereof. The invention is not, however, limited thereto, and other materials may be used. For example, those persons skilled in the art will appreciate other non-ferromagnetic metals may be useful in the invention. In some embodiments, the electrically conductive filler material is copper powder, copper flakes or silver coated copper flakes.

In some embodiments, at least one filler material is a material having a low coefficient of thermal contraction and at least one filler material is an electrically conductive material. In some embodiments, the first filler material is a material having a low coefficient of thermal contraction and the second filler material is an electrically conductive material. In some other embodiments, the first filler material and the second filler material are materials having a low coefficient of thermal contraction and a third filler material is an electrically conductive material.

Certain filler materials may also modify multiple properties of the polymer composition. For example, carbon powder has a low coefficient of thermal contraction and is electrically conductive.

Any of the filler materials according to the present invention may comprise a coating.

Accordingly, the particles of the first filler material may comprise a coating of an electrically conductive material. Suitable electrically conductive materials include, for example, metals and metal oxides such as chromium, nickel, copper, silver, gold, aluminium, titanium, oxides thereof and mixtures of any two or more thereof. However, those persons skilled in the art will appreciate other electrically conductive materials, such as other non-ferromagnetic metals, may be useful in the invention. Preferably, the electrically conductive material is titanium. Preferably, the first filler material is a material having a low coefficient of thermal contraction coated with an electrically conductive material. In some embodiments, the first filler material is titanium coated diamond. In some embodiments, the polymer composition comprises a first filler material that is titanium coated diamond, a second filler material that is alumina, and a third filler material is diamond. Advantageously, the variation in resistivity with temperature of a composition comprising particles of a filler material comprising a coating of an electrically conductive material may be reduced compared with that of a composition comprising particles of a filler material consisting of an electrically conductive material. In some embodiments, the resistivity of the composition comprising particles of a filler material coated with an electrically conductive material does not substantially change with temperature.

Suitable coated filler materials may be prepared using various techniques known to those skilled in the art including, but not limited to, electroless plating and vapour deposition.

In some embodiments, the particles of at least one filler material comprise an electrically conductive material coated with a different electrically conductive material. For example, in some embodiments, at least one filler material is silver coated copper.

In some embodiments, the median particle size of the first filler material comprising a coating of an electrically conductive material is about 5 μm to about 100 μm, or about 5 μm to about 50 μm, or about 5 μm to about 40 μm, or about 5 μm to about 30 μm, or about 9.5 μm to about 50 μm, or about 9.5 μm to about 40 μm, or about 9.5 μm to about 29 μm, or about 25.2 μm, or about 25 μm, or about 20 μm, or about 12.5 μm, or about 12.4 μm.

Those persons skilled in the art can select the amount of each filler material to be included in the polymer composition. Those skilled persons may take into account the nature of the filler material and the desired properties of the polymer composition and resulting polymer impregnated HTS coil. The total amount of filler materials included in the polymer composition may be, by weight of the polymer composition, in the range of about 10% to about 70%, for example, in an amount of about 10%, or about 15%, or about 20%, or about 25%, or about 30%, or about 35%, or about 40%, or about 45%, or about 50%, or about 55%, or about 60%, or about 65%, or about 70%.

In some embodiments, the polymer composition comprises a first filler material in an amount, by weight of the polymer composition, of about 10% to 50%, or about 20% to about 40%, or about 30%. In some embodiments, the polymer composition comprises a filler material having a low coefficient of thermal contraction in an amount, by weight of the polymer composition, of about 1% to 40%, or about 10% to about 30%, or about 20%. In some embodiments, the polymer composition comprises a filler material having a low coefficient of thermal contraction in an amount, by weight of the polymer composition, of about 30% to about 70%, or about 40% to 60%, or about 50%. In some embodiments, the polymer composition comprises an electrically conductive filler material in an amount, by weight of the polymer composition, of about 1% to about 40%, or about 5% to about 30%, or about 10% to about 20%.

Those persons skilled in the art will appreciate that the polymer resin may be any thermosetting polymer resin that is suitable for impregnating an HTS coil. Preferred polymer resins have a long pot life, high Young's modulus and cryogenic serviceability. The pot life of the polymer resin should be sufficiently long to allow winding of a full coil without appreciable curing of the resin. In some embodiments, a polymer resin having a low curing temperature, for example, less than 60° C., is used. Advantageously, such use may minimise damage to other components of the coil during the curing process. For instance, when a coil is prepared with a low temperature solder, a polymer resin having a low curing temperature may be selected to avoid destabilising the solder joints during the curing process. Suitable polymer resins include, for example, epoxies, polyimides, polyethylenes, polyacrylates, polyurethanes and combinations of any two or more thereof. In some embodiments, the polymer resin is selected from the group consisting of epoxies, polyimides, polyethylenes, polyacrylates and polyurethanes. In a preferred embodiment, the polymer resin is an epoxy resin, for example, a primary amine cured bisphenol-A/bisphenol-F blend epoxy resin, such as CTD-521.

The polymer composition of the present invention may be used to prepare a polymer impregnated HTS coil. The coil comprises a winding component that is formed into the shape of a coil such as a single pancake coil, a double pancake coil or a racetrack coil. The polymer composition is impregnated in the coil such that it forms layers between the turns of the winding component resulting in a composite sandwich structure.

The winding component comprises an HTS material. Suitable HTS materials include, for example, rare earth barium copper oxide (REBCO) superconductor materials; bismuth, thallium or mercury-based superconductor materials (for example, BSCCO, TBCCO and HBCCO); other cuprate-based superconductor materials; magnesium diboride and Fe-based superconductor materials. Preferably, the HTS material is a REBCO material containing, for example, yttrium, samarium, neodymium, gadolinium or a combination thereof, such as YBa₂Cu₃O_{7-δ} (YBCO) or GdBa₂Cu₃O_{7-δ} (GdBCO). The invention is not, however, limited thereto, and other HTS materials may be used.

The coil may further comprise one or more co-wind materials. Suitable co-wind materials include, for example, copper, copper alloys (such as brass), silver, titanium and steel (for example, stainless steel), or an alloy, such as nickel-molybdenum alloys (for example, Hastelloy C276).

The HTS material and, when present, the co-wind material may be in any geometry suitable for forming a coil such as a cable, strip, tape or wire. In some embodiments, the HTS material and, when present, the co-wind material each independently have a substantially planar surface transverse to the winding direction of the coil such that the interface between layers is substantially planar. Generally, high aspect materials are preferred. In some embodiments, the HTS material and, when present, the co-wind material each independently have a width-to-thickness ratio of at least 10.

The polymer impregnated HTS coil of the present invention may be prepared by conventional “wet winding” methods. For example, the polymer composition of the invention may be applied to the surface of the winding component. The coated winding component may then be wound into a coil and the polymer cured to provide the polymer impregnated HTS coil. In some embodiments, the steps of applying the polymer composition to the surface of the winding component and winding the coil are performed concurrently.

The following non-limiting examples are provided to illustrate the present invention and in no way limit the scope thereof.

### EXAMPLES

In the following examples, unless stated otherwise, the HTS coils were prepared by wet winding a commercially supplied 4 mm width REBCO superconductor tape electroplated with 20 μm of copper on both sides, coated with a CTD-521 resin (supplied by Composite Technology Development). CTD-521 resin is a primary amine cured bisphenol-A/bisphenol-F blend epoxy resin. The resin is supplied in two parts, A and B, that are mixed prior to use. The resin may be filled by the supplier. For example, CTD-521-A20 is filled to 20% by weight with alumina powder having a maximum size less than 1 μm.

Unless stated otherwise, the amorphous diamond used in the following examples had a median particle size of 12.5 μm with a standard deviation of approximately 5 μm.

Silver coated copper flakes were used as an electrically conductive material. Silver coating minimises surface oxidation of the copper. The copper flakes had a maximum particle size of less than 3 μm.

### Example 1: Comparison of Polymer Compositions With and Without Gauging Particles

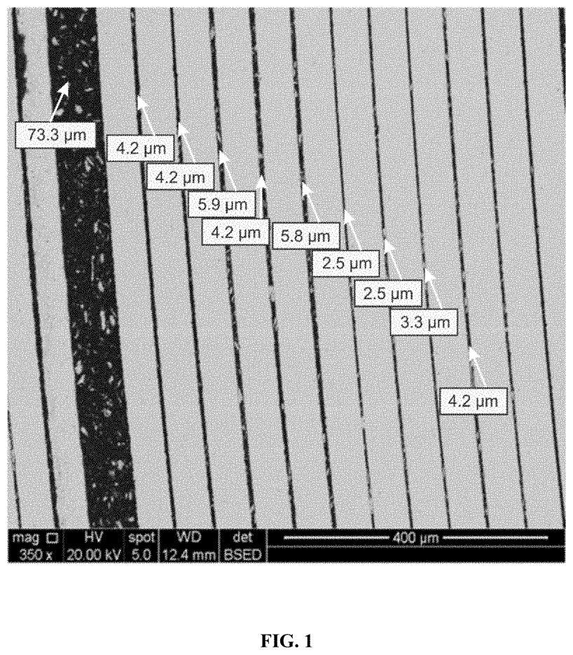

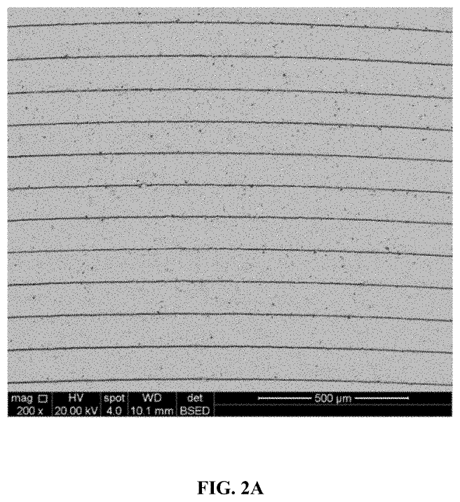

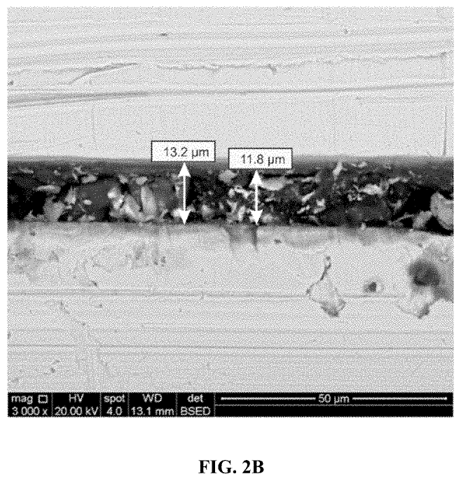

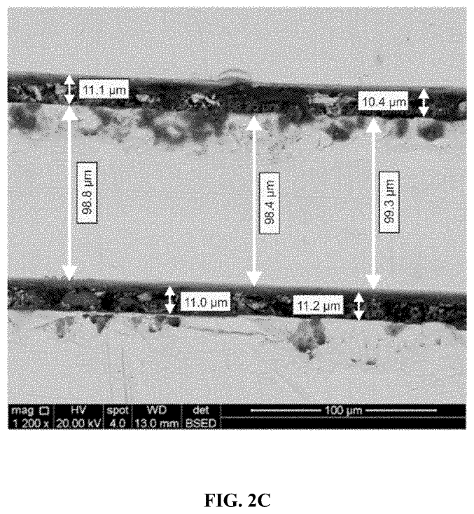

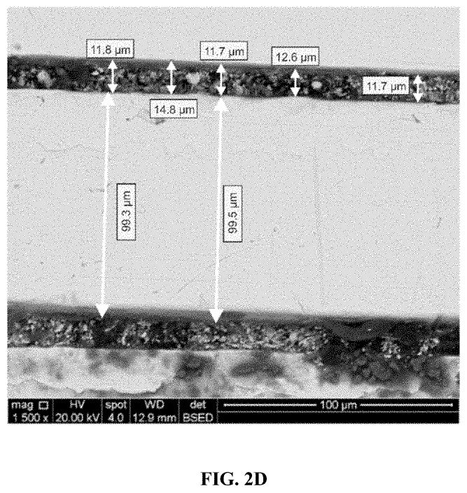

Two polymer compositions were prepared to evaluate the effects of gauging particles on the turn-to-turn spacing of an HTS coil impregnated with the composition. The first polymer composition contained gauging particles. The composition was prepared from a CTD-521-A20 resin, copper flakes having a maximum particle size of 3 μm, and amorphous diamond particles having a median particle size of 12.5 μm with a standard deviation of approximately 5 μm. The diamond particles were added to the bisphenol (part A) of the epoxy in an amount of 60% by weight of diamonds to part A of the epoxy and uniformly dispersed. The second polymer composition was a comparative example that did not contain gauging particles. The comparative polymer composition was prepared from CTD-521-A20 and copper flakes having a maximum particle size of 3 μm. SEM was used to image HTS coils impregnated with each polymer composition. FIG. 2 shows cross sections of the HTS coil impregnated with the first polymer composition. The white regions are conductor and the black regions are epoxy. FIG. 2A shows a cross section of a coil that has been wound using the first polymer composition. FIGS. 2B-2D show that at the randomly selected locations near the centre, middle and outer regions of the coil, the turn-to-turn spacing is set by the size of the diamond particles. FIG. 1 shows a cross section of the HTS coil impregnated with the comparative polymer composition that does not contain gauging particles. Small flecks can be seen in the epoxy regions, which are predominately the copper flakes or alumina. Comparison of the two coils demonstrates that the uniformity of turn-to-turn spacing is significantly improved in the HTS coil impregnated with the polymer composition comprising gauging particles.

### Example 2: Evaluation of Different Gauging Particles

Once the gauging effect of epoxy resins comprising gauging particles was observed and measured, a simpler technique was developed and used to verify the gauging effect for different size gauging materials. Initially, a metallic tape was used to dry wind a coil of known inner diameter (ID). The tape had a uniform thickness and similar dimensions to those of the superconductor. Once the required number of turns were wound, the outer diameter (OD) of the coil was measured. The dry coil was then unwound. The following formula can be used to calculate the thickness of each coil turn, which is also the thickness of the metallic tape:

$$Coil turn thickness = \frac{0.5 OD - 0.5 ID}{Number of turns}$$

The same piece-length of metallic tape was then used to wind an epoxy impregnated coil. The coil was wound using the same process as the dry-wound coil, but with the additional step of painting an epoxy resin filled with gauging material onto the surface of the metallic tape immediately prior to winding. Once the full length of tape had been wound onto the coil, the OD of the epoxy impregnated coil was measured, and the same formula used to calculate the average turn thickness. The turn thickness now includes both the tape thickness and the epoxy thickness. The difference between the two outer diameters must therefore give the epoxy thickness, which is in turn set by the size of the gauging material.

Six coils were wound with different sizes and types of gauging materials and examined using this method to verify the gauging concept. The results are shown in Table 1. Coil 1 and coil 2 were wound without any additional filler material for reference. Coil 3 used 6 g of diamonds as a filler with a nominal D₅₀ of 9.7 μm, D₅ of 8 μm and D₉₅ of 12 μm. The coil achieved an inter-layer thickness close to the nominal D₅₀ of the diamond filler. Coil 4 was wound using an alumina filler with a D₉₅ of 30 μm. Other particle size parameters were unknown. The coil achieved gauging of 24.7 μm. Similarly, addition of an alumina filler with a D₉₅ of 15 μm as in coil 5 achieved gauging of 10.7 μm. Addition of additional filler particles with D₉₅ smaller than the first (15 μm) gauging material as in coil 6 achieved the same gauging as coil 5, demonstrating that the turn-to-turn spacing is set by the largest particle size.

TABLE 1

| | Copper | | | | | | | |
|---|---|---|---|---|---|---|---|---|
| | tape | | Dry coil | Epoxied | | | | Turn |
| Coil | thickness | Number | OD | coil OD | ID | | Added | spacing |
| number | [μm] | of turns | [mm] | [mm] | [mm] | Epoxy | filler(s) | [μm] |
| Coil 1 | 102.6 | 200 | 65.71 | 68.45 | 24.59 | CTD-521 | None | 7 |
| | | | | | | A20 26.8 g | | |
| Coil 2 | 101.8 | 200 | 65.60 | 68.54 | 24.87 | CTD-521 | None | 7.4 |
| | | | | | | A20 26.8 g | | |
| Coil 3 | 102.7 | 160 | 57.87 | 60.81 | 24.97 | CTD-521 | Diamonds 6 g | 9.2 |
| | | | | | | A20 26.8 g | D₅₀ 9.7 μm | |
| Coil 4 | 101.0 | 200 | 65.5 | 75.18 | 24.9 | CTD-521 | Alumina 6 g | 24.7 |
| | | | | | | A20 26.8 g | D₉₅ 30 μm | |
| Coil 5 | 101.4 | 200 | 65.42 | 69.70 | 24.84 | CTD-521 | Alumina 6 g | 10.7 |
| | | | | | | A20 26.8 g | D₉₅ 15 μm | |
| Coil 6 | 102.3 | 200 | 65.81 | 70.11 | 25.85 | CTD-521 | 1. Alumina 6 g, | 10.8 |
| | | | | | | A20 26.8 g | D₉₅ 15 μm | |
| | | | | | | | 2. Alumina 12 g | |
| | | | | | | | D₉₅ 5 μm | |
| | | | | | | | 3. Silica 4 g | |
| | | | | | | | D₉₅ 1 μm | |

The second set of coil winding examples followed the inverse process. The design of the coil, i.e. the ID, OD, conductor thickness and number of turns, was specified. Since the turn-to-turn thickness of the coil is now fixed, the thickness of the resin layer required to achieve the turn-to-turn thickness is also fixed. The size of the gauging particle may now be determined, and hence used to fill an epoxy resin. Table 2 shows the details of five coils co-wound with superconductor and titanium tapes using this process. The number of turns reported in the table refers only to the superconductor. Coils 7, 8, 9 and 10 used amorphous diamonds for gauging with a D₅₀ of 12.4 μm, and a D₅ and D₉₅ of 8 and 18 μm, respectively. Coil 11 used amorphous diamonds for gauging with a D₅₀ of 25.2 μm, and a D₅ and D₉₅ of 18 and 37 μm, respectively. In all cases the copper was copper flake particle with major particle length D₅₀ of 2 μm.

TABLE 2

| | | | | | | | | First | |
|---|---|---|---|---|---|---|---|---|---|
| | | | | OD | OD | | | filler | |
| | Material | Number | ID | required | obtained | | First | particle | Second |
| Coil | thickness | of turns | [mm] | [mm] | [mm] | Epoxy | filler | size [μm] | filler |
| Coil 7, | 88 μm SC | 72 | 30.6 | 60.56 | 60.83 (7) | CTD-521 | Diamonds | 12.4 | Copper |
| Coil 8 | 88 μm Ti | | | | 60.79 (8) | A20 | 9 g | | 15.5 g |
| | | | | | | 20.1 g | | | |
| Coil 9, | 88 μm SC | 100.4 | 48.22 | 88.56 | 88.45 (9) | CTD-521 | Diamonds | 12.4 | Copper |
| Coil 10 | 88 μm Ti | | | | 88.61 (10) | A20 | 9 g | | 15.5 g |
| | | | | | | 20.1 g | | | |
| Coil 11 | 81 μm SC | 93 | 247 | 287.82 | 288 (11) | CTD-521 | Diamonds | 25.2 | Copper |
| | 88 μm Ti | | | | | A20 | 39 g | | 37 g |
| | | | | | | 87.2 g | | | |

The diameters of the coils were measured with traditional Vernier callipers; a measurement error of +/−0.05 mm was expected for every diameter measurement. This error, for a coil of 200 turns corresponds to a +/−0.2 μm error in the calculation of the resin thickness.

The superconducting coils were wet co-wound with superconductor tape and titanium tape of similar thickness. The coil turn thickness in the calculation includes the superconductor (SC) thickness, the titanium thickness and two layers of epoxy resin. The resin thickness reported in the table refers to a single resin layer between the copper cladding of the HTS and the titanium.

### Example 3: Evaluation of Electrically Conductive Material Containing Polymer Compositions

When a superconducting coil is wound, it is possible to calculate the resistivity by performing a sudden discharge measurement. This method involves operating a coil at a current below its critical current (I_{C}) and allowing the magnetic field produced by the coil to stabilise. The coil is then open circuited, causing the magnet current to dissipate as heat through the coil winding turn-to-turn resistance. The rate at which the magnetic field at the centre of the coil decays is used to calculate the turn-to-turn resistance. The method for calculating resistivity is outlined in Wang et al. Supercond Sci Technol 2013, 26, 1-6.

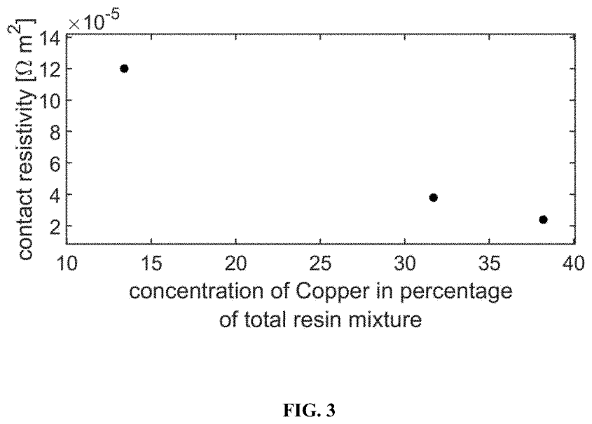

To evaluate the use of electrically conductive filler particles for modifying the resistivity of an HTS coil, a series of small polymer impregnated test coils were prepared with varying amounts of copper filler particles. The coils had an ID of 25 mm and an OD of 45 mm comprising 50 turns of superconducting wire. The coils were co-wound with a titanium wire (0.175 mm). The polymer composition for these coils was prepared from a CTD-521-A20 epoxy with 15 g of part A, 5.1 g of part B and 9 g of 12.5 μm amorphous diamond powder, to which copper flakes were added in an amount of 4.5 g for test coil 12, 13.5 g for test coil 13 and 18 g for test coil 14. The turn-to-turn resistivity of the coils was calculated by the method outlined in Wang et al. Supercond Sci Technol 2013, 26, 1-6. The results, as shown in FIG. 3, indicate the turn-to-turn resistivity of a polymer impregnated HTS coil may be modified by varying the amount of copper flakes added to the polymer composition.

### Example 4: Validation of Coil Performance

The thermal stability of a coil comprising gauging particles and a material having a low coefficient of thermal contraction was evaluated by subjecting two test coils, coil 13 and coil 15, to repeated thermal cycles and observing whether thermal degradation had occurred. Coil 13 was the same coil comprising 13.5 g copper from Example 3. Coil 15 was a larger coil having an ID of 247 mm, and an OD of 288 mm. Coil 15 was impregnated with a CTD-A521-A20 epoxy prepared with 65 g part A, 22.1 g part B, 39 g amorphous diamond powder and 61.1 g of copper flakes.

The superconducting performance of a superconductor coil was measured by performing a critical current test. The critical current is the current at which the coil or conductor transitions from being a superconductor to a normal conductor. Far below the critical current, a superconductor has zero resistance meaning that current can be injected into the superconductor without measuring any voltage. As the superconductor approaches its critical current, the voltage obeys a power law behaviour with increased current. If damage occurs to a superconductor for thermal or any other reasons, it is observable immediately by reduction in the critical current performance, or by a reduction in the sharpness of the transition between superconducting and normal states.

No significant degradation was observed in coil 13 or coil 15 upon repeated thermal cycles.

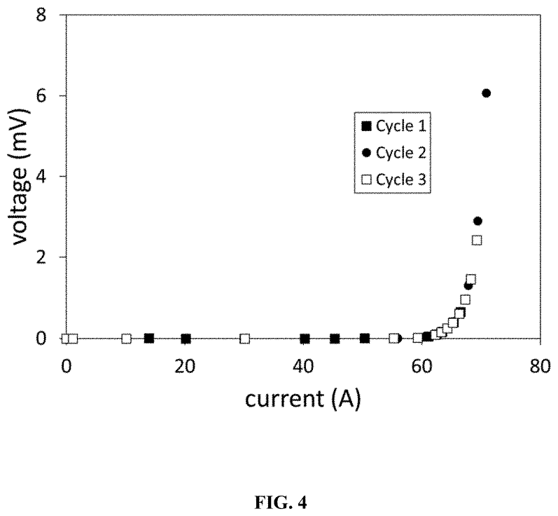

FIG. 4 shows the critical current curves of coil 13 for three successive thermal cycles between room temperature and 77 K. The coil is said to transition between the superconducting and normal states when it exceeds the voltage demarked by the dashed line.

### Example 5: Polymer Compositions Comprising Titanium-Coated Diamond Particles

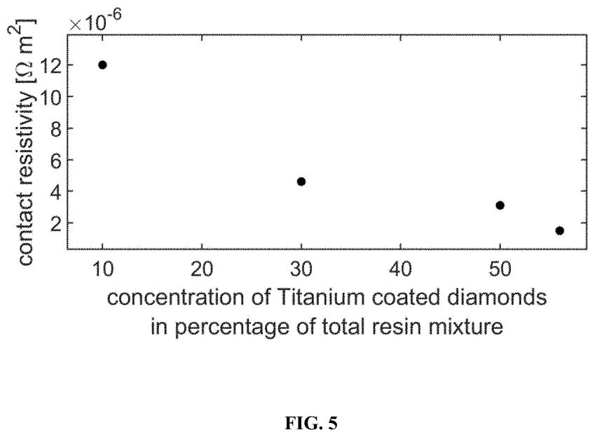

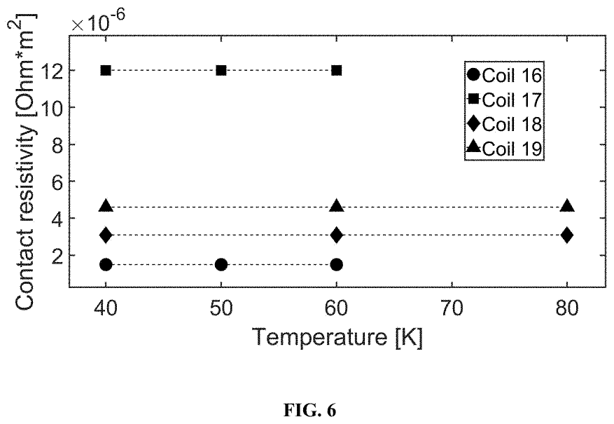

A series of small coils were wound using an epoxy filled with varying amounts of coated and uncoated diamond particles. The coils were wound using 100 g of CTD-521-A20, which as noted above comprises 20% by weight of 1 μm alumina powder (a second filler material). The coils comprised 50 turns co-wound with titanium ribbon having a thickness of 83.6 μm and REBCO superconductor having a thickness of 90 μm. The coils are detailed further in Table 3. The contact resistivity of each of the coils was assessed at 40 K. An approximately linear relationship between the concentration of titanium coated diamonds and the contact resistivity was observed, as shown in FIG. 5. The contact resistance of coils 16, 17 18 and 19 was assessed at different temperatures and shown to have little variation between temperatures (FIG. 6).

TABLE 3

| | ID | OD | | First filler | First filler | Third | Third filler | Third filler |
|---|---|---|---|---|---|---|---|---|
| Coil | [mm] | [mm] | First filler | d₅₀ (μm) | weight (g) | filler | d₅₀ (μm) | weight (g) |
| Coil 16 | 25.13 | 48.36 | Ti coated | 20 um | 130 | — | — | — |
| | | | diamond | | | | | |
| Coil 17 | 25.11 | 47.68 | Ti coated | 20 um | 20 | Uncoated | 20 um | 80 |
| | | | diamond | | | diamond | | |
| Coil 18 | 25.36 | 47.9 | Ti coated | 20 um | 100 | — | — | — |
| | | | diamond | | | | | |
| Coil 19 | 25.1 | 47.8 | Ti coated | 20 um | 60 | Uncoated | 20 um | 40 |
| | | | diamond | | | diamond | | |

It is not the intention to limit the scope of the invention to the above mentioned examples only. As would be appreciated by a skilled person in the art, many variations are possible without departing from the scope of the invention as set out in the accompanying claims.

1. A polymer composition for impregnating a high temperature superconductor (HTS) coil, the composition comprising:
a polymer resin,
a plurality of particles of a first filler material, and
a plurality of particles of a second filler material;
wherein the median particle size of the second filler material is less than the median particle size of the first filler material.

2. The polymer composition of claim 1, wherein the aspect ratio of the particles of a first filler material is above about 0.80.

3. The polymer composition of claim 1 or 2, wherein the particles of the first filler material are substantially spherical or substantially cubic.

4. The polymer composition of any one of claims 1-3, wherein the median particle size of the first filler material is about 5 μm to about 50 μm.

5. The polymer composition of any one of claims 1-4, wherein the median particle size of the first filler material has a standard deviation of about 40% of the particle size.

6. The polymer composition of any one of claims 1-5, wherein the maximum particle size of the second filler material is less than the median particle size of the first filler material.

7. The polymer composition of any one of claims 1-6, wherein the maximum particle size of the second filler material is less than about 3 μm.

8. The polymer composition of any one of claims 1-7, wherein the first filler material and the second filler material are independently selected from the group consisting of a material having a low coefficient of thermal contraction and an electrically conductive material.

9. The polymer composition of any one of claims 1-8, wherein the first filler material is diamond.

10. The polymer composition of any one of claims 1-9, wherein the particles of the first filler material comprise a coating of an electrically conductive material.

11. The polymer composition of claim 10, wherein the electrically conductive material comprising the coating is titanium.

12. The polymer composition of any one of claims 1-11, wherein the polymer composition further comprises a plurality of particles of a third filler material, and wherein the median particle size of the third filler material is less than the median particle size of the first filler material.

13. The polymer composition of claim 12, wherein the maximum particle size of the third filler material is less than the median particle size of the first filler material.

14. The polymer composition of claim 12 or 13, wherein the maximum particle size of the third filler material is less than about 3 μm.

15. The polymer composition of any one of claims 1-11, wherein the polymer composition further comprises a plurality of particles of a third filler material, and wherein the median particle size of the third filler material is substantially equal to the median particle size of the first filler material.

16. The polymer composition of any one of claims 12-15, wherein the third filler material is selected from the group consisting of a material having a low coefficient of thermal contraction and an electrically conductive material.

17. The polymer composition of claim 8 or 16, wherein the material having a low coefficient of thermal contraction is selected from the group consisting of silica, quartz, carbon powder, diamond, amorphous diamond, boron nitride, alumina, aluminium nitride, zinc oxide, zirconium oxide, magnesium oxide and mixtures of any two or more thereof.

18. The polymer composition of claim 8 or 16, wherein the electrically conductive material is selected from the group consisting of metals, metal oxides, carbon and mixtures of any two or more thereof.

19. The polymer composition of claim 18, wherein the metals or metal oxides are selected from the group consisting of nickel, chromium, copper, silver, gold, aluminium, titanium, oxides thereof and mixtures of any two or more thereof.

20. The polymer composition of claim 18, wherein the carbon is selected from the group consisting carbon powder, carbon black, carbon fibres, carbon nanofibres, graphite, graphene and mixtures of any two or more thereof.

21. The polymer composition of any one of claims 12-20, wherein the first and second filler materials have a low coefficient of thermal contraction and the third filler material is electrically conductive.

22. The polymer composition of any one of claims 12-21, wherein the first filler material is diamond, the second filler material is alumina and the third filler material is copper flakes.

23. The polymer composition of any one of claims 12-20, wherein the first filler material is titanium coated diamond, the second filler material is alumina and the third filler material is diamond.

24. The polymer composition of any one of claims 1-23, wherein the polymer resin is selected from the group consisting of epoxies, polyimides, polyethylenes, polyacrylates, polyurethanes and combinations of any two or more thereof.

25. The polymer composition of any one of claims 1-24, wherein the polymer resin is an epoxy.

26. A polymer impregnated HTS coil comprising:
a winding component comprising an HTS material,
wherein the coil is impregnated with the polymer composition of any one of claims 1-25.

27. A method of producing a polymer impregnated HTS coil, the method comprising the steps of:
a) providing a winding component comprising an HTS material,
b) applying the polymer composition of any one of claims 1-25 to the winding component,
c) winding the coated winding component obtained from step b) into a coil, and
d) curing the coil obtained from step c) to provide the polymer impregnated HTS coil.

28. The polymer impregnated HTS coil of claim 26 or the method of claim 27, wherein the winding component further comprises one or more co-wind materials.

29. The polymer impregnated HTS coil or method of claim 28 wherein the one or more co-wind materials are independently selected from the group consisting of copper, copper alloys, silver, titanium, steel and nickel-molybdenum alloys.

30. The polymer impregnated HTS coil of any one of claims 26-29 or the method of any one of claims 27-29, wherein the HTS material is a REBCO tape.

31. Use of a polymer composition of any one of claims 1-25 for preparing a polymer impregnated HTS coil having a predetermined turn-to-turn spacing.
